(19) United States
(12) Patent Application Publication
(10) Pub. No.: US 2024/0102527 A1
(43) Pub. Date: Mar. 28, 2024

(54) ENERGY ABSORBING BUSHING

(71) Applicant: Adient US LLC, Plymouth, MI (US)

(72) Inventors: Richard Joseph MAYER, Plymouth, MI (US); Martin P. MURAU, Ann Arbor, MI (US); Steven LIVESEY, Walled Lake, MI (US); Evan E. JARCZEWSKI, Livonia, MI (US); Dinesh Kumar Reddy REDDI VARI, Kalakada (IN)

(73) Assignee: Adient US LLC, Plymouth, MI (US)

(21) Appl. No.: 18/471,342

(22) Filed: Sep. 21, 2023

Related U.S. Application Data
(60) Provisional application No. 63/376,786, filed on Sep. 23, 2022.

(30) Foreign Application Priority Data
Sep. 23, 2022 (IN) 202211054541

(51) Int. Cl. F16F 1/38; F16F 1/377

(52) U.S. Cl. CPC F16F 1/38; F16F 1/377; F16F 2234/02

(57) ABSTRACT

An energy absorbing bushing may have a base portion and a tubular portion attached to the base portion, and a split extending through the base portion and the tubular portion. The split may have three portions each at a different angle with respect to one another.

### FIELD

This application relates to a bushing including an energy absorbing bushing, which may be used for a seat.

### BACKGROUND

Bushings are commonly used as linings for apertures or holes. A bushing may be used to limit the size of the aperture, to resist abrasion or facilitate movement between two or more parts, and/or it may serve as a guide.

As a further example, a bushing may also be used in a vehicle seat, such as at a pivot joint between two seat parts to provide the function noted above. A bushing used in this example may need to be constructed of metal and coated with a material, such as Teflon, to withstand the forces between the two parts and also to provide the needed lubricity between the parts.

These prior art designs, however, are problematic because they require tight, often unsustainable tolerances in the bushing, bushing aperture and seat parts. Namely, in the past, it was desirable to produce a bushing that fit as tightly as possible with its respective part(s). Doing so would remove any clearance between the bushing and the part(s). However, to produce such a bushing expended considerable time and money and didn't fully mitigate noise and/or vibration between the parts and the bushing. Such a bushing made little sense in the field of high-volume seat production.

In view of the disadvantages associated with the prior art designs, it would be advantageous to provide a low friction bushing to facilitate movement between two parts and to absorb energy to dampen vibrations in the parts where dimensional tolerances of the parts and bushing are obtainable in terms of cost and time.

### SUMMARY

In one embodiment, an energy absorbing bushing may have a base portion and a tubular portion extending generally transverse the base portion. The base portion may have an inner diameter and an outer diameter and upper and lower surfaces bounded by the diameters. The tubular portion may have a bearing portion with an outer diameter less than the outer diameter of the base portion, and an inner diameter that is substantially the same as the inner diameter of the base portion. The tubular portion may also have a working portion of the tubular portion that is adjacent the bearing portion. The working portion may have an inner diameter that is substantially the same as the inner diameter of the bearing portion, and an outer diameter that is greater than the outer diameter of the bearing portion. The tubular portion may also have a lead-in portion that is adjacent the working portion. The lead-in portion may be angled radially inward so that an inner diameter of the lead in portion is smaller than the inner diameter of the working portion. The tubular portion may also have a nose portion that is adjacent the lead in portion, the nose portion having a tapered shape. A split may extend axially from the nose portion to the base portion.

In another aspect, the base may have a substantially constant thickness.

In another aspect, the bushing may be unitary, one piece and integrally formed.

In another aspect, the bushing may be constructed of plastic.

In another aspect, the split may be Z-shaped having three parts that are angled with respect to one another.

In another aspect, a first part of the split may extend through the base at a first angle.

In another aspect, a second part of the split may extend at least partially through the bearing portion at a second angle different than the second angle.

In another aspect, a third part of the split may extend at least partially through lead-in portion at a third angle different than the second angle.

In another aspect, the bushing may have a base portion and a tubular portion attached to the base portion, and a split extending through the base portion and the tubular portion to provide the bushing with a C-shaped cross-section. The split may be defined by three portions each at a different angle with respect to one another.

In another aspect, a first part of the split may extend through the base at a first angle.

In another aspect, a second part of the split may extend at least partially through the bearing portion at a second angle different than the second angle.

In another aspect, a third part of the split extends at least partially through lead-in portion at a third angle different than the second angle.

### BRIEF DESCRIPTION OF THE DRAWINGS

FIG. 1A is a front perspective view of one embodiment of a bushing;

FIG. 1B is another front perspective view of the bushing in FIG. 1A;

FIG. 1C is a rear perspective view of the bushing in FIG. 1A;

FIG. 2 depicts a schematic, cut away side view of the bushing;

FIG. 3 depicts a perspective view of one embodiment of a seat frame in which bushings have been installed on a part;

FIG. 4 depicts a perspective view of a component of the part from FIG. 3 with the bushings installed;

FIG. 5 is a cross-sectional view taken through two bushings installed in a part with a fastener located through the bushings and the part; and

FIG. 6 is a schematic detail of a portion of FIG. 5.

### DETAILED DESCRIPTION OF THE PREFERRED EMBODIMENTS

It is to be understood that the bushing may assume various alternative orientations and step sequences, except where expressly specified to the contrary. It is also to be understood that the specific bushing illustrated in the attached drawings, and described in the following specification is simply an exemplary embodiment of the concepts discussed and depicted herein. Hence, specific dimensions, directions or other physical characteristics relating to the embodiments disclosed are not to be considered as limiting.

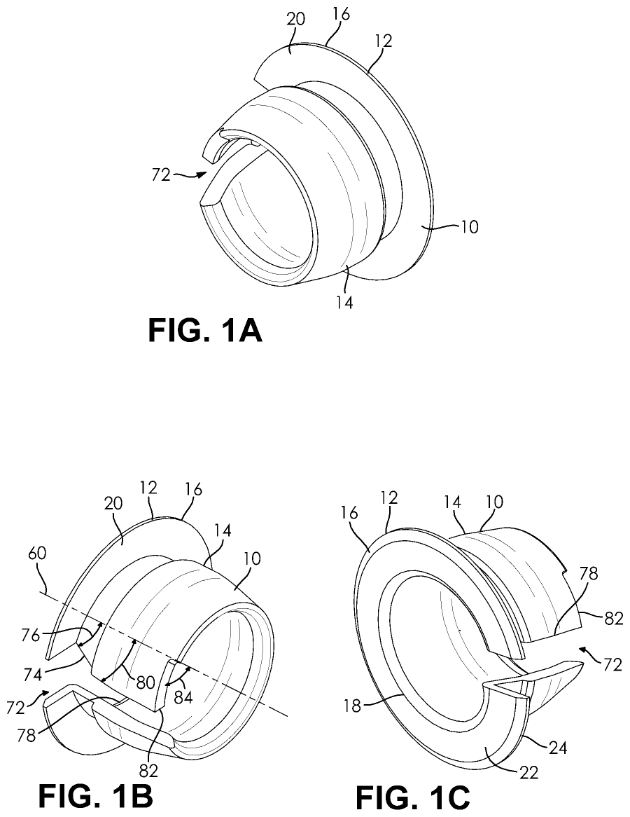

Turning now to FIGS. 1A-C and 2, one embodiment of a bushing 10 is depicted. The bushing 10 may be one piece, integrally formed and unitary. In some embodiments, the bushing 10 may be constructed of plastic. By way of one example, the plastic may be such as conditioned, non-glass, nylon 66. The conditioned status may refer the fact that the nylon 66 has absorbed water or otherwise hydrated. While conditioned, non-glass, nylon 66 is mentioned other materials that have perform as described below may be used.

The bushing 10 may have a base portion 12 and a generally tubular portion 14. The primary direction of the tubular portion 14 may be generally transverse the primary direction of the base portion 12. The base portion 12 may have an outer perimeter 16 that may be generally circular in shape but the outer perimeter 16 may also be curvilinear in shape, such as defined by a plurality of joined facets.

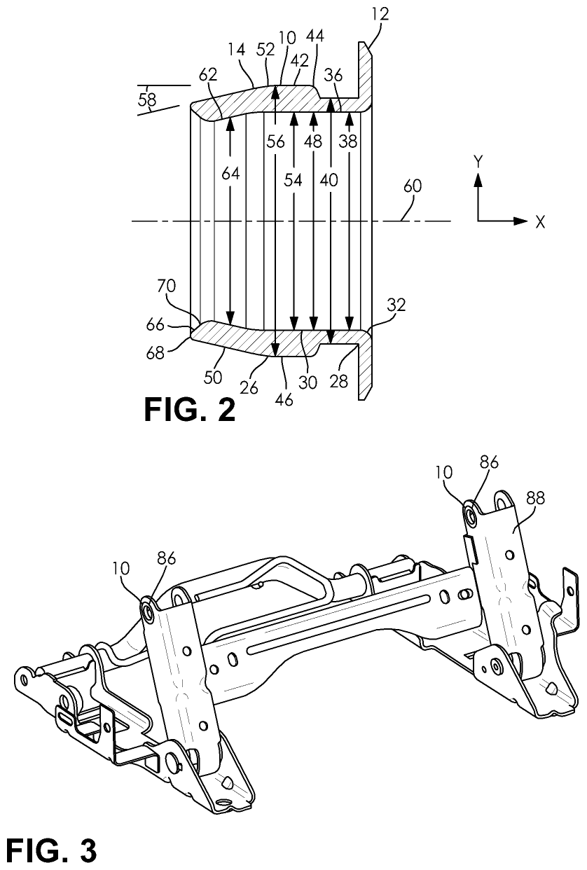

The base portion 12 may also have an inner diameter 18 that is smaller than the outer perimeter 16. The inner diameter 18 may also be generally circular in shape, but it may also be curvilinear, such as defined by a plurality of joined facets. The inner diameter 18 may be located directly radially inward from the outer perimeter. Radial may be such as along the y-axis, as shown in FIG. 2.

The base portion 12 may also have upper and lower surfaces 20, 22 that are bounded by the inner diameter 18 and outer perimeter 16. The upper and lower surfaces 20, 22 may be generally planar and define a substantially constant thickness between them. In some embodiments, however, an outer portion 24 of the base portion 12 may taper down in thickness in a radially outward direction, which may be seen in FIG. 2. The base portion 12 may be substantially solid in its construction with no intervening apertures or interruptions in its surfaces 20, 22.

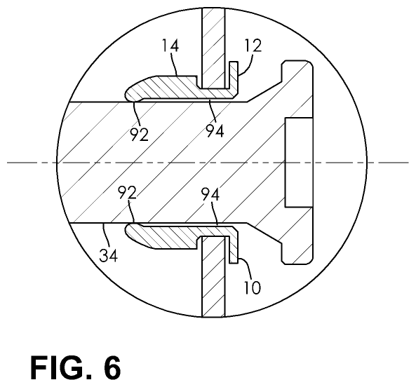

The base portion 12 may be directly connected to the tubular portion 14 such that there are no intervening structures. In one embodiment, the upper surface 20 may transition to an outer surface 26 of the tubular portion 14 at a first radius 28. The lower surface 22 of the base portion 22 may transition to an inner surface 30 of the tubular portion 14 at a second radius 32, where the second radius 32 may be larger than the first radius 28. At least the second radius 32 may facilitate locating a shaft 34 into the bushing 10, as shown in FIGS. 5-6, as the radius 32 avoids sharp edges that may catch the shaft 34.

The tubular portion 14 may be such as an arm cantilevered from the base portion 12. The arm may have a bearing portion 36 located adjacent the base portion 12. The bearing portion 36 may have a substantially constant inner diameter 38 and a substantially constant outer diameter 40 defining a substantially constant thickness between them. The thickness of the bearing portion 36 may be substantially the same as the thickness of the base portion 12. The bearing portion outer diameter 40 may be smaller than the base portion outer perimeter 18. However, the bearing portion inner diameter 38 may be substantially the same as the base portion inner diameter 18.

Adjacent the bearing portion 36 may be a working portion 42. The working portion 42 may be characterized by an increase thickness in the radial direction in the material of the arm compared with the bearing portion 36. In some cases, the thickness of the working portion 42 may be about double that of the bearing portion 36. A radiused transition 44 from the outer diameter 40 of the bearing portion 36 to an outer surface 46 of the working portion 42 contributes to the increased thickness of the working portion 42. An inner diameter 48 of the working portion 42 may be substantially the same as the inner diameter 38 of the bearing portion 36.

The thickness and shape of the working portion 42 urges a lead-in portion 50 of the arm into engagement with the shaft 34 that may selectively extend through the bushing 10, such as shown in FIGS. 5 and 6. By way of one example, the working portion 42 may be part of a central portion 52 of the arm. The central portion 52 of the arm may have an inner and outer diameter 54, 56 that may be substantially constant so that a substantially constant thickness is defined between them.

The lead-in portion 50 may axially extend from the central portion 52 but it may do so at an angle. Namely, the lead-in portion 50 may be provided with an angle 58 so that the lead-in portion 50 extends radially inwardly toward a central axis 60 of the bushing 10. The angle 58 may be between approximately 5 to 25 degrees and preferably between 10-15 degrees.

From the above, it can be appreciated that an inner surface 62 of the lead-in portion 50 may have a smaller inner diameter 64 compared to the inner diameter 54 of the central portion 52. Further, the inner diameter 64 of the lead-in portion 50 may not be constant but instead it may decrease in an axial outward direction due to the angle 58.

A nose portion 66 of the lead-in portion 50 may be tapered in some embodiments. In one example, the taper may extend so that an outer surface 68 of the nose portion 66 may extend a greater axial distance than an inner surface 70 of the nose portion 66. The shape of the nose portion 66 may facilitate locating the shaft 34 into the bushing 10 in that the angled nose portion 66 may direct the shaft 34 into, or along, the bushing 10.

The bushing 10 may also be provided with a split 72. The split 72 may extend from the lead-in portion 50 between the nose portion 66 to the base portion 12. The extension may be continuous and without interruption. The split 72 may extend in a curved, angled and/or multi-faceted manner. In one embodiment, the split 72 may provide the bushing with a C-shaped cross section or simply an overall general C-shape, which may be appreciated from FIG. 1C.

In one embodiment, the split 72 may be Z-shaped, which may be seen in FIGS. 1A-C. The Z-shape may be comprised of three parts that are angled with respect to one another. A first part 74 of the shape may be located in the base portion 12. The first part 74 may extend through the base portion 12 to at least part of the bearing portion 36 at a first angle 76 with respect to the central axis 60. The first angle 76 may be such as an acute angle. The second part 78 of the shape may be connected to the first part 74, and it may extend at least partially through the bearing portion 36, and perhaps into the lead-in portion 50, at a second angle 80 with respect to the central axis 60, which may be different than the first angle 76. The second angle 80 may be less than the first angle 76. The third part 82 of the shape may be connected to the second part 78, and it may extend at least partially through the lead-in portion 50 at a third angle 84 with respect to the central axis 60, and the nose portion 66, which may be different than the second angle 80. The third angle 84 may be larger than the first or second angles 76, 80; it may be approximately 90 degrees.

The split 72 permits the bushing 10 to be selectively compressed so that it can be located within an aperture 86 or hole, such as in a seat portion 88, as shown in FIGS. 3-6. Namely, the split 72 provides a space into which the bushing 10 may move when the bushing 10 is compressed so as to reduce the bushing 10 outer diameter.

The shape of the split 72 also advantageously enables the shaft 34 to be substantially radially encompassed by the bushing 10. In other words, even with the split 72 the bushing 10 supports the shaft 34 substantially circumferentially such that axial portions of the shaft 34 are in some circumferential contact with the bushing 10. Further, the shape of the split 72 prevents the shaft 34 from radially extending out of the bushing 10 because the bushing is circumferentially wrapped about the shaft 34.

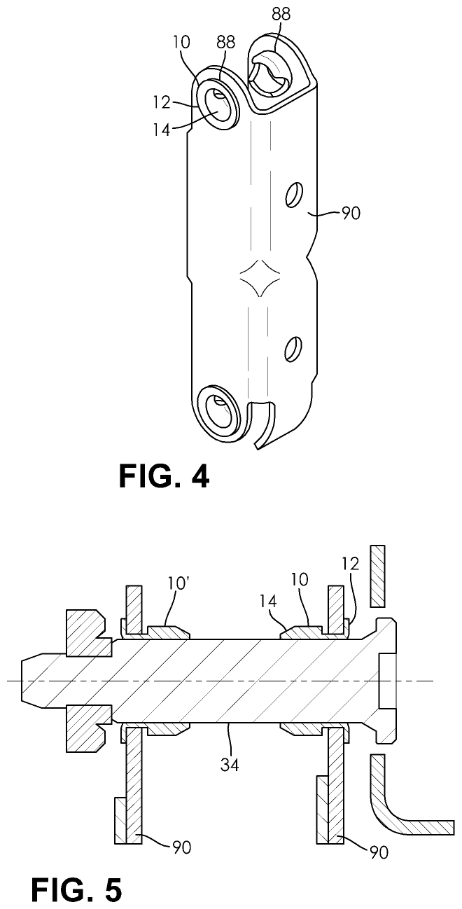

FIGS. 3 and 4 depict one embodiment of the seat portion 88 in which the bushing 10 may be located. From the figures, particularly FIG. 4, it can be seen that the bushing 10 may be located so that the nose portion 66 is inserted into the aperture 66 into the seat portion 88, which in the depicted embodiment may be a link 90. The outer surface 68 of the nose portion 66 may be smaller than the diameter of the aperture 86 in which the bushing 10 is to be inserted. However, the outer diameter 56 of the central portion 52 may be same size or larger than the aperture 86. The flexible nature of the bushing material, as well as the split 72, permits the bushing 10 to flex or compress so that the bushing 10 can be inserted into the aperture 86 until the base portion 12, having a larger outer perimeter 16 than the aperture 86, contacts the portion of the part surrounding the aperture 86 and prevents the bushing 10 from moving further.

FIG. 5 depicts the condition where the shaft 34, such as from a fastener, is located within two bushings 10, 10′ that are positioned within apertures 86 in a seat portion 88. As the fastener can only be inserted in a single direction, it can be appreciated that the bushings 10, 10′ are adapted to receive a fastener through either the base portion 12 or the nose portion 66.

FIG. 6 depicts a detail from FIG. 5. FIG. 6 illustrates that a radial interference 92, or portion of substantially constant contact between the shaft 34 and the nose portion 66 is provided while a radial clearance 94 is provided for substantially the remainder of the axial distance between the shaft 34 and the bushing 10. The interference 92 and clearance 94 permits the bushing 10 to be inserted relatively loosely within the part aperture 86, which facilitates assembly, but nevertheless the bushing 10 is located relatively tightly about the shaft 34, at least via the nose portion 66, to mitigate or eliminate relative movement of the parts once they are assembled to reduce noise. More particularly, the nose portion 66 of the bushing 10 in direct contact with the shaft 34 receives vibration or movement from the shaft 34, and the nose portion 66, being cantilevered and constructed of a flexible material, acts as an energy absorbing spring for vibration/movement.

In accordance with the provisions of the patent statutes, the device has been described in what is considered to represent its preferred embodiments. However, it should be noted that the device can be practiced otherwise than as specifically illustrated and described without departing from its spirit or scope.

What is claimed is:

1. An energy absorbing bushing, comprising:
a base portion and a tubular portion extending generally transverse the base portion,
wherein the base portion has an inner diameter and an outer diameter and upper and lower surfaces bounded by the diameters,
wherein the tubular portion has a bearing portion with an outer diameter less than the outer diameter of the base portion, and an inner diameter that is substantially the same as the inner diameter of the base portion,
wherein a working portion of the tubular portion is adjacent the bearing portion, the working portion having an inner diameter that is substantially the same as the inner diameter of the bearing portion, and an outer diameter that is greater than the outer diameter of the bearing portion;
wherein a lead-in portion is adjacent the working portion, the lead-in portion angled radially inward so that an inner diameter of the lead in portion is smaller than the inner diameter of the working portion,
wherein a nose portion is adjacent the lead-in portion, the nose portion having a tapered shape, and
a split that extends axially from the nose portion to the base portion.

2. The energy absorbing bushing of claim 1, wherein the base has a substantially constant thickness.

3. The energy absorbing bushing of claim 1, wherein the bushing is unitary, one piece and integrally formed.

4. The energy absorbing bushing of claim 3, wherein the bushing is constructed of plastic.

5. The energy absorbing bushing of claim 1, wherein the split is Z-shaped having three parts that are angled with respect to one another.

6. The energy absorbing bushing of claim 5, wherein a first part of the split extends through the base at a first angle.

7. The energy absorbing bushing of claim 6, wherein a second part of the split extends at least partially through the bearing portion at a second angle different than the second angle.

8. The energy absorbing bushing of claim 7, wherein a third part of the split extends at least partially through lead-in portion at a third angle different than the second angle.

9. An energy absorbing bushing, comprising:
a base portion and a tubular portion attached to the base portion, and a split extending through the base portion and the tubular portion to provide the bushing with a C-shaped cross-section, wherein the split is defined by three portions each at a different angle with respect to one another.

10. The energy absorbing bushing of claim 9, wherein a first part of the split extends through the base at a first angle.

11. The energy absorbing bushing of claim 10, wherein a second part of the split extends at least partially through the bearing portion at a second angle different than the second angle.

12. The energy absorbing bushing of claim 11, wherein a third part of the split extends at least partially through lead-in portion at a third angle different than the second angle.
